(19) United States
(12) Patent Application Publication
(10) Pub. No.: US 2009/0115307 A1
(43) Pub. Date: May 7, 2009

(54) COMPOSITION FOR ARCING AND CHARGING PREVENTION FILM AND FIELD EMISSION DEVICE INCLUDING ARCING AND CHARGING PREVENTION FILM FORMED FROM THE SAME

(76) Inventor: Myung-Ick Hwang, Suwon-si (KR)

Correspondence Address: CHRISTIE, PARKER & HALE, LLP, PO BOX 7068, PASADENA, CA, 91109-7068, US

(21) Appl. No.: 12/265,463

(22) Filed: Nov. 5, 2008

(30) Foreign Application Priority Data
Nov. 5, 2007 (KR) 10-2007-0112300

(51) Int. Cl. H01J 1/52; C03C 3/14

(52) U.S. Cl. 313/313; 501/49

(57) ABSTRACT

Compositions for forming arcing and charging prevention films, arcing and charging prevention films formed from the compositions, and field emission devices including the arcing and charging prevention films are provided. The composition includes from about 50 to about 90 wt % of an inorganic oxide, from about 5 to about 30 wt % of an organic vehicle, and from about 1 to about 45 wt % of glass frit. The arcing and charging prevention films have excellent adhesive force and are stable even in vibration or vacuum conditions. Therefore, field emission devices including the arcing and charging prevention films have high uniformity and stability.

### CROSS-REFERENCE TO RELATED PATENT APPLICATIONS

This application claims priority to and the benefit of Korean Patent Application No. 10-2007-0112300, filed on Nov. 5, 2007 in the Korean Intellectual Property Office, the entire content of which is incorporated herein by reference.

### BACKGROUND OF THE INVENTION

1. Field of the Invention

The present invention relates to compositions for arcing and charging prevention films and to field emission devices including arcing and charging prevention films formed from the compositions.

2. Description of the Related Art

In general, field emission devices are categorized into hot cathode field emission devices using hot cathodes as electron emitters and cold cathode field emission devices using cold cathodes as electron emitters. Examples of cold cathode field emission devices include field emitter array (FEA)-type field emission devices, surface conduction emitter (SCE)-type field emission devices, metal insulator metal (MIM)-type field emission devices, metal insulator semiconductor (MIS)-type field emission devices, and ballistic electron surface emitting (BSE)-type field emission devices.

Field emission devices can also be categorized into high-voltage field emission devices and low-voltage field emission devices according to the amount of the applied voltage. In low-voltage field emission devices, a low voltage of 400 to 1000V is applied to the anode. In high-voltage field emission devices, a high voltage of 1 kV to 10 kV is applied to the anode.

In general, a field emission device includes a rear panel and a front panel coupled to the rear panel. The rear panel includes a substrate, a cathode, a gate electrode, an insulating layer, and an electron emitter. The front panel includes a fluorescent layer and an anode. Electrons are emitted from the electron emitter when a voltage is applied to the cathode, and the electrons are accelerated towards the fluorescent layer. The accelerated electrons excite the fluorescent layer, thereby generating visible light.

During operation of the field emission device, charging occurs at the cathode and at the anode due to collisions of electrons. Charges are gradually accumulated during operation of the field emission device and an arcing phenomenon occurs. Arcing damages the anode and decreases the lifetime of the device. Arcing often occurs in high-voltage field emission devices and causes serious problems. Arcing also occurs in low-voltage field emission devices.

To prevent the accumulation of charges and arcing, an arcing and charging prevention film (which can comprise an inorganic oxide) can be formed on the anode and cathode. Specifically, conventional arcing and charging prevention films include mixtures of inorganic oxides and organic vehicles, and are formed on the anode or cathode, but only the inorganic oxide remains in the arcing and charging prevention film when the organic vehicle is sintered. Therefore, the arcing and charging prevention film can peel away from the anode or cathode during operation of the field emission device, or the inorganic oxide may become dispersed and contaminate the anode or cathode such that the generated arc damages the field emission device.

### SUMMARY OF THE INVENTION

According to one embodiment of the present invention, a composition for forming an arcing and charging prevention film forms such a film that has excellent adhesive force, making the film stable in vibration or vacuum conditions. The composition is suitable for forming a field emission device having high uniformity and high stability. According to another embodiment, a field emission device includes an arcing and charging prevention film formed from the composition.

According to an embodiment of the present invention, a composition for forming an arcing and charging prevention film for a field emission device includes from about 50 to about 90 wt % of an inorganic oxide, from about 5 to about 30 wt % of an organic vehicle, and from about 1 to about 45 wt % of glass frit.

According to another embodiment of the present invention, a field emission device includes an arcing and charging prevention film having an inorganic oxide and glass frit.

### BRIEF DESCRIPTION OF THE DRAWINGS

The above and other features and advantages of the present invention will become more apparent by reference to the detailed description when considered in conjunction with the following drawing, in which:

FIG. 1 is a schematic cross-sectional view of a field emission device including an arcing and charging prevention film according to an embodiment of the present invention.

### DETAILED DESCRIPTION OF THE INVENTION

According to an embodiment of the present invention, a composition for forming an arcing and charging prevention film has high adhesive force and thus, when an arcing and charging prevention film is formed from the composition and formed on an anode or cathode, the arcing and charging prevention film is stabile even under vibration or vacuum conditions. Therefore, a field emission device including the arcing and charging prevention film can have high uniformity and high stability.

The composition for forming an arcing and charging prevention film according to an embodiment of the present invention includes from about 50 to about 90 wt % of an inorganic oxide, from about 5 to about 30 wt % of an organic vehicle, and from about 1 to about 45 wt % of glass frit. When the amount of each component is within these ranges, the viscosity of the composition may be suitable for printing. The arcing and charging prevention film can obtain higher adhesive force after drying and sintering. Therefore, the arcing and charging prevention film can be stabile during operation of the field emission device. When the amount of the glass frit is greater than about 45 wt %, the specific resistance of the composition increases such prevention of the arching phenomenon by preventing charging cannot be effectively achieved.

The glass frit of the composition for forming an arcing and charging prevention film according to an embodiment of the present invention has a low melting point and may have a sintering temperature ranging from about 300 to about 400° C. In one embodiment, for example, the sintering temperature ranges from about 300 to about 350° C. When the glass frit is sintered within this temperature range, the electron emitter is protected during sintering in the formation of the arcing and charging prevention film on the anode or cathode. The glass frit stabilizes the resulting arcing and charging prevention film by binding with the inorganic oxide and the anode or cathode.

According to an embodiment of the present invention, the glass frit can be selected from SnO—B₂O₃—TeO₂-based compounds, SnO—P₂O₅—B₂O₃-based compounds, or PbO—B₂O₃—SiO₂-based compound compounds. In the SnO—B₂O₃—TeO₂-based glass frit, the amounts of SnO and TeO₂ may range from about 1 to about 6 parts by weight (SnO) and from about 0.3 to about 3 parts by weight (TeO₂), based on 1 part by weight of B₂O₃. When the amounts of SnO and TeO₂ in the SnO—B₂O₃—TeO₂-based glass frit are within these ranges, the glass frit can be sintered within the above sintering temperature range and can stabilize the arcing and charging prevention film by binding with the inorganic oxide and the anode or cathode during sintering. In addition, the thermal expansion coefficient of the arcing and charging prevention film can be adjusted.

In the PbO—B₂O₃—SiO₂-based glass frit, the amounts of PbO, B₂O₃, and SiO₂ may range from about 50 to about 80 wt % (PbO), from about 5 to about 30 wt % (B₂O₃), and from about 1 to about 15 wt % (SiO₂). In some cases, the PbO—B₂O₃—SiO₂-based glass frit can further include about 5% or less of additives.

In the SnO—P₂O₅—B₂O₃-based glass frit, the amounts of SnO, P₂O₅, and B₂O₃ may range from about 1 to about 30 wt % (SnO), from about 50 to about 80 wt % (P₂O₅), and from about 1 to about 20 wt % (B₂O₃). In some cases, the SnO—P₂O₅—B₂O₃-based glass frit can further include about 5% or less of additives.

The inorganic oxide of the composition for forming an arcing and charging prevention film according to an embodiment of the present invention can be any conductive inorganic oxide, but the present invention is not limited thereto.

The conductive inorganic oxide may include at least one transition metal oxide selected from Cr₂O₃, CoO, and NiO. For example, the conductive inorganic oxide can be Cr₂O₃.

The organic vehicle of the composition for forming an arcing and charging prevention film according to an embodiment of the present invention may include a cellulose-based binder and an organic solvent. The cellulose-based binder may include at least one cellulose selected from ethylcellulose, hydroxymethylcellulose, hydroxyethylcellulose, carboxymethylcellulose, carboxyethylcellulose, carboxyethylmethylcellulose, and combinations thereof.

In the organic vehicle, the amount of the cellulose-based binder may range from about 5 to about 30 parts by weight based on 100 parts by weight (the total weight) of the organic vehicle. When the amount of the cellulose-based binder is within this range, the viscosity of the composition is suitable for printing, and the amount of coal remaining after sintering is not excessive.

According to an embodiment of the present invention, the organic solvent can include at least one compound selected from ethylcarbitol, butylcarbitol, ethylcarbitolacetate, butylcarbitolacetate, texanol, terpine oil, dipropyleneglycolmethylether, dipropyleneglycolethylether, dipropyleneglycolmonomethyletheracetate, γ-butyrolactone, cellosolveacetate, butylcellosolveacetate, tripropyleneglycol, and combinations thereof.

In the organic vehicle, the amount of the organic solvent may range from about 50 to about 90 parts by weight based on 100 parts by weight (the total weight) of the organic vehicle. When the amount of the organic solvent is within this range, the viscosity of the composition for forming an arcing and charging prevention film is suitable for printing, and the organic solvent used can be removed in a relatively short time period by drying.

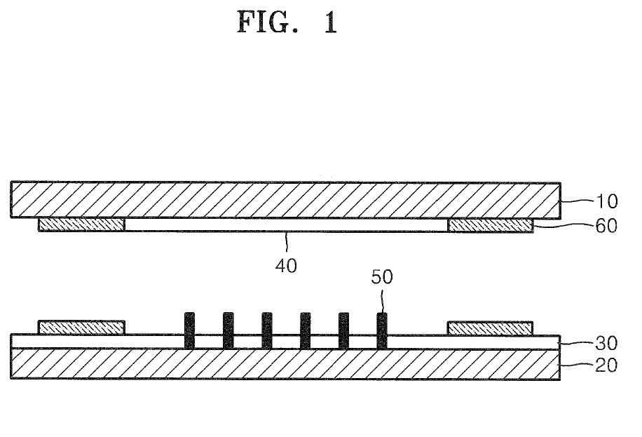

An arcing and charging prevention film of a field emission device according to an embodiment of the present invention includes an inorganic oxide and glass frit. FIG. 1 is a schematic cross-sectional view of a field emission device including an arcing and charging prevention film 60 according to an embodiment of the present invention. Referring to FIG. 1, arcing and charging prevention films 60 are disposed at both sides of a fluorescent layer 40 on the anode 10, and at both sides of a plurality of electron emitters 50 on an insulating layer 30 disposed on the cathode 20.

The field emission device with the arcing and charging prevention film according to the present invention has the same structure as conventional field emission devices, except for the components of the arcing and charging prevention film.

The field emission device includes a rear panel and a front panel, wherein the rear panel includes a rear substrate, a cathode, a gate electrode, an insulating layer, and a plurality of electron emitters. The front panel includes a front substrate, a fluorescent layer and an anode.

The rear substrate is a panel having a thickness. The cathode may extend in any direction on the rear substrate, and can be formed of any known electrically conductive material. The gate electrode can also be formed of any known electrically conductive material.

The insulating layer is disposed between the gate electrode and the cathode, and insulates the cathode from the gate electrode to prevent shorts between the gate electrode and the cathode. The insulating layer has a plurality of electron emitter holes in which the electron emitters are electrically connected to the cathode and an arcing and charging prevention film is formed on the insulating layer.

The electron emitters are disposed on the cathode such that the electron emitters are electrically connected to the cathode, and are located beneath the gate electrodes. The electron emitters can include any known carbon-based material.

The anode is disposed on the front substrate, and the fluorescent layer and an arcing and charging prevention film are disposed on the anode. A high voltage is applied to the anode to accelerate electrons which have been emitted from the electron emitters such that the electrons can collide with the fluorescent layer at high speed. A spacer is disposed between the front panel and the rear panel.

The arcing and charging prevention film can be formed by printing a composition for forming an arcing and charging prevention film including an inorganic oxide, an organic vehicle, and glass frit on the anode or cathode, drying the printed layer to remove the used solvent, and then sintering the resultant product at a temperature to remove the used binder.

According to an embodiment of the present invention, the glass frit of the arcing and charging prevention film of the field emission device illustrated in FIG. 1 can be a SnO—B₂O₃—TeO₂-based, SnO—P₂O₅—B₂O₃-based or PbO—B₂O₃—SiO₂-based compound. The organic solvent and the binder are removed from the composition for forming an arcing and charging prevention film by the printing, drying, and sintering processes. Therefore, after sintering, the proportions of the inorganic compounds in the glass frit are the same as the proportions of the inorganic compounds in the composition for forming the arcing and charging prevention film. That is, when the glass frit of the arcing and charging prevention film of the field emission device illustrated in FIG. 1 is a SnO—B₂O₃—TeO₂-based compound, amounts of SnO and TeO₂ of the SnO—B₂O₃—TeO₂-based glass frit can range from about 1 to about 6 parts by weight (SnO) and from about 0.3 to about 3 parts by weight (TeO₂) based on 1 part by weight of B₂O₃.

According to an embodiment of the present invention, the inorganic oxide can be a conductive inorganic oxide. Specifically, the conductive inorganic oxide can include at least one transition metal oxide selected from Cr₂O₃, CoO, and NiO. For example, the inorganic oxide can be Cr₂O₃.

Thee present invention will now be described with reference to the following examples. These examples are presented for illustrative purposes only and do not limit the scope of the present invention.

Mixing and milling devices and furnaces are not limited, and can be any known devices.

### EXAMPLE

### Preparation of SnO—B₂O₃—TeO₂-Based Glass Frit

40 g of SnO, 20 g of B₂O₃, and 20 g of TeO₂ were mixed for 30 minutes in a mixing device, and then allowed to stand in a furnace at 1200° C. for 1 hour. Then, the resultant product was cooled at 25° C. and milled using a milling device to obtain SnO—B₂O₃—TeO₂-based glass frit.

### Preparation of Composition for Arcing and Charging Prevention Film

35 g of SnO—B₂O₃—TeO₂-based glass frit, 5 g of ethylcellulose, 25 g of butylcarbitolacetate, and 35 g of Cr₂O₃ were mixed in a mixing device at a speed of 1000 rpm for 20 minutes, and then milled in a 3-roll milling device to obtain a composition for forming an arcing and charging prevention film.

### Fabrication of Field Emission Device

The composition for forming an arcing and charging prevention film was printed on a final anode and a final cathode, and dried at 150° C. for 20 minutes to remove the used solvent, and sintered at 350° C. for 30 minutes to remove the used binder. In this manner, an arcing and charging prevention film was formed on each of the anode and the cathode.

### COMPARATIVE EXAMPLE

A composition for an arcing and charging prevention film was prepared as in the Example described above, except that glass frit was not used. The obtained composition was printed, dried, and sintered in the same manner as described above to form an arcing and charging prevention film on the anode and cathode.

Field emission devices prepared according to the Example and Comparative Example were operated at 15 kV for 1000 hours. The arcing and charging prevention film of the field emission device prepared according to the Comparative Example peeled off and thus, arcing occurred and the field emission device was damaged. On the other hand, the arcing and charging prevention film of the field emission device prepared according to the Example was securely attached to each of the anode and cathode, thus preventing arcing during operation of the field emission device.

The arcing and charging prevention films of field emission devices according to the present invention are formed from compositions for forming arcing and charging prevention films and have high adhesive forces. Therefore, the arcing and charging prevention films retain their stability under vibration or vacuum conditions. Furthermore, a field emission devices including the arcing and charging prevention films have high uniformity and high stability.

While the present invention has been illustrated and described with reference to certain exemplary embodiments, it will be understood by those of ordinary skill in the art that various changes and modifications to the described embodiments may be made without departing from the spirit and scope of the present invention as defined by the following claims.

What is claimed is:

1. A composition for forming an arcing and charging prevention film for a field emission device, the composition comprising from about 50 to about 90 wt % of an inorganic oxide, from about 5 to about 30 wt % of an organic vehicle, and from about 1 to about 45 wt % of glass frit.

2. The composition of claim 1, wherein the glass frit has a sintering temperature ranging from about 300 to about 400° C.

3. The composition of claim 1, wherein the glass frit is selected from the group consisting of SnO—B₂O₃—TeO₂-based compounds, SnO—P₂O₅—B₂O₃-based compounds, and PbO—B₂O₃—SiO₂-based compounds.

4. The composition of claim 3, wherein the glass frit comprises a SnO—B₂O₃—TeO₂-based glass frit, wherein an amount of SnO ranges from about 1 to about 6 parts by weight based on 1 part by weight of B₂O₃, and an amount of TeO₂ ranges from about 0.3 to about 3 parts by weight based on 1 part by weight of B₂O₃.

5. The composition of claim 3, wherein the glass frit comprises a SnO—P₂O₅—B₂O₃-based glass frit, wherein an amount of SnO ranges from about 1 to about 30 wt %, an amount of P₂O₅ ranges from about 50 to about 80 wt %, and an amount of B₂O₃ ranges from about 1 to about 20 wt %.

6. The composition of claim 3, wherein the glass frit comprises a PbO—B₂O₃—SiO₂-based glass frit, wherein an amount of PbO ranges from about 50 to about 80 wt %, an amount of B₂O₃ ranges from about 5 to about 30 wt %, and an amount of SiO₂ ranges from about 1 to about 15 wt %.

7. The composition of claim 1, wherein the inorganic oxide comprises a conductive inorganic oxide.

8. The composition of claim 7, wherein the conductive inorganic oxide is selected from the group consisting of Cr₂O₃, CoO, NiO, and combinations thereof.

9. The composition of claim 1, wherein the organic vehicle comprises a cellulose-based binder and an organic solvent.

10. The composition of claim 9, wherein the cellulose-based binder is selected from the group consisting of ethylcellulose, hydroxymethylcellulose, hydroxyethylcellulose, carboxymethylcellulose, carboxyethylcellulose, carboxyethylmethylcellulose, and combinations thereof.

11. The composition of claim 9, wherein the organic solvent is selected from the group consisting of ethylcarbitol, butylcarbitol, ethylcarbitolacetate, butylcarbitolacetate, texanol, terpine oil, dipropyleneglycolmethylether, dipropyleneglycolethylether, dipropyleneglycolmonomethyletheracetate, γ-butyrolactone, cellosolveacetate, butylcellosolveacetate, tripropyleneglycol, and combinations thereof.

12. A field emission device comprising an arcing and charging prevention film comprising an inorganic oxide and glass frit.

13. The field emission device of claim 12, wherein the glass frit is selected from the group consisting of SnO—B₂O₃—TeO₂-based compounds, SnO—P₂O₅—B₂O₃-based compounds, and PbO—B₂O₃—SiO₂-based compounds.

14. The field emission device of claim 13, wherein the glass frit comprises SnO—B₂O₃—TeO₂-based glass frit, wherein an amount of SnO ranges from about 1 to about 6 parts by weight based on 1 part by weight of B₂O₃ and an amount of TeO₂ ranges from about 0.3 to about 3 parts by weight based on 1 part by weight of B₂O₃.

15. The field emission device of claim 13, wherein the glass frit comprises a SnO—P₂O₅—B₂O₃-based glass frit, wherein an amount of SnO ranges from about 1 to about 30 wt %, an amount of P₂O₅ ranges from about 50 to about 80 wt %, and an amount of B₂O₃ ranges from about 1 to about 20 wt %.

16. The field emission device of claim 13, wherein the glass frit comprises a PbO—B₂O₃—SiO₂-based glass frit, wherein an amount of PbO ranges from about 50 to about 80 wt %, an amount of B₂O₃ ranges from about 5 to about 30 wt %, and an amount of SiO₂ ranges from about 1 to about 15 wt %.

17. The field emission device of claim 12, wherein the inorganic oxide comprises a conductive inorganic oxide.

18. The field emission device of claim 17, wherein the conductive inorganic oxide is selected from the group consisting of Cr₂O₃, CoO, NiO, and combinations thereof.
